(19) United States
(12) Patent Application Publication
(10) Pub. No.: US 2015/0202470 A1
(43) Pub. Date: Jul. 23, 2015

(54) Suspension Device

(71) Applicant: Shaodun HE, (US)

(72) Inventor: Shaodun He, Shenzhen (CN)

(21) Appl. No.: 14/417,171

(22) PCT Filed: Dec. 26, 2012
(86) PCT No.: PCT/CN2012/087495

§ 371 Date: Jan. 26, 2015

(30) Foreign Application Priority Data
May 10, 2012 (CN) 201220208056.2
Sep. 19, 2012 (CN) 201210349151.9
Dec. 13, 2012 (CN) 201210537108.5
Dec. 21, 2012 (CN) 201210560474.2

(51) Int. Cl. A62B 1/14

(52) U.S. Cl. CPC A62B 1/14

(57) ABSTRACT

The present invention provides a suspension device. A U-shaped rope-penetrating part is arranged on a suspension body; the U-shaped mouth of the U-shaped rope-penetrating part together with the suspension body form a rope-penetrating hole; a suspension hole is set in a position to one side, and a control handle which controls the deflection of the suspension device is also provided. When the human body is independently borne by the suspension hole, the fixed end and the free end of the suspend rope are pressed tightly with each other to prevent the suspend rope from sliding; the human body is suspended on the high, and the suspension device is in a self-locking state. When the human body exerts pulling force on the suspension device through the control handle, the suspension device deflect, at this time, the human body begins to descend with the rope sliding.

### FIELD OF THE INVENTION

The present invention relates to a suspension device, in particular relates to a suspension device that descends due to body's own weight of gravity and through manual control.

### BACKGROUND ART

The existing 8-shaped ring suspension device is characterized by a simple structure, easy to operate, so it is widely used for rock climbing, caving, working at heights, aerial rappelling etc. However, the disadvantage is that it finds a self-locking difficulty. In actual use, people have to apply continuous pulling force to the free end of the suspend rope in a bid to control the rate of descent. In case it needs to hover in the air for a long time, the free end of the suspend rope must be fixed; for this reason, in using the existing 8-shaped ring suspension device, there are potentially certain safety risks for those without professional training due to inconvenient operation.

### BRIEF SUMMARY OF THE INVENTION

In order to overcome the self-locking difficulty for the existing 8-shaped ring suspension device and potential safety risks during use, the present invention provides a suspension device. A U-shaped rope-penetrating part is arranged on a suspension body; the U-shaped mouth of the U-shaped rope-penetrating part together with the suspension body form a rope-penetrating hole; a suspension hole which bears weight of a human body is set in a position to one side, and a control handle which controls the deflection of the suspension device is also provided. During use, the fixed end of the suspend rope is fixed on high, the free end of the suspend rope droops to the lower place, and the human body is fixed and connected with the suspension hole. When the human body is independently borne by the suspension hole, the fixed end and the free end of the suspend rope are pressed tightly with each other to prevent the suspend rope from sliding; the human body is suspended on the high, and the suspension device is in a self-locking state. When the human body exerts pulling force on the suspension device through the control handle, the suspension device deflects so as to reduce the pressure between the fixed end and the free end or separate the fixed end from the free end; at this time, the human body begins to descend with the rope sliding.

The technical solution provided in the present invention is: The suspension device comprises a suspension body with a suspension hole and a U-shaped rope-penetrating part arranged on the suspension body; the U-shaped mouth of the U-shaped rope-penetrating part together with the suspension body form a rope-penetrating hole; the said suspension hole is set in a position to one side, and a control handle which controls the deflection of the suspension device is also provided on the other side of the suspension body; the suspend rope passes through the rope-penetrating hole and is muff-coupled with the waist of the suspension body; the fixed end of the suspend rope passes through the rope-penetrating hole and then is fixed on high, the free end of the suspend rope passes through the rope-penetrating hole and droops to the lower place, and the human body is fixed and connected with the suspension hole by fasteners. When the human body is independently borne by the suspension hole, the fixed end and the free end of the suspend rope touch and press tightly with each other to prevent the suspend rope from sliding and keep the human body suspended on the high. When the human body exerts pulling force on the suspension device through the control handle, the suspension device deflects so as to reduce the pressure between the fixed end and the free end or separate the fixed end from the free end; at this time, the human body begins to descend with the rope sliding.

The optimized embodiment of the present invention: The said U-shaped rope-penetrating part is made by bending round steels; the said suspension body is provided with fixed jacks; the two pins of the said U-shaped rope-penetrating part are inserted and welded in the fixed jacks respectively.

The optimized embodiment of the present invention: The said U-shaped rope-penetrating part and suspension body are integrated casting structure.

The optimized embodiment of the present invention: The said U-shaped rope-penetrating part and suspension body is integrated casting structure, and the said U-shaped rope-penetrating part is made by bending round steels.

The optimized embodiment of the present invention: The control handle is folding handle, the said folding handle can be adopted on the suspension body with pin roll, the suspension body has handle locating part, and the folding handle can rotate around the pin roll and be located with locating part.

The optimized embodiment of the present invention: The suspension device is structured of double control handle; control handles which control the deflection of suspension device are located on both sides of said suspension body.

The optimized embodiment of the present invention: The said U-shaped rope-penetrating part is obliquely fastened on the suspension body.

The optimized embodiment of the present invention: A U-shaped rope-penetrating part is provided on each of the two sides of the said suspension body.

The optimized embodiment of the present invention: The said suspension hole is located to one side and in a place below the waist of the suspension body. The said control handle is located in a place below the waist of the suspension body and on the other side of the suspension hole.

The optimized embodiment of the present invention: The said suspension hole is located to one side and in a place below the waist of the suspension body. The said control handle is located in a place above the waist of the suspension body and on the other side of the suspension hole.

The optimized embodiment of the present invention: The said suspension hole is located to one side and in a place above the waist of the suspension body. The said control handle is located in a place below the waist of the suspension body and on the other side of the suspension hole.

The optimized embodiment of the present invention: The said suspension hole is located to one side and in a place above the waist of the suspension body. The said control handle is located in a place above the waist of the suspension body and on the other side of the suspension hole.

The present invention prompts that the control handle is the pressure point to control the deflection of the suspension device. In addition, a pull cord instead of a control handle can be adopted on the other side of the suspension hole to control the deflection of the suspension device. Anything can be used to achieve the purposes of the present invention as the control handle does, as long as it can facilitate the deflection of the suspension device.

The benefit of the present invention is: The suspension device as described in the present invention, provided with a control handle on one side of the suspension hole to control the deflection of the suspension device, features a self-locking function which can guarantee the safety of users. When necessary, the human body can descend by exerting pulling force on the suspension device with the control handle to force the suspension device to deflect so as to release self-locking. It is easy to operate.

### BRIEF DESCRIPTION OF THE DRAWINGS

FIG. 1 to FIG. 3 are the schematic views of the existing 8-shaped ring suspension device. FIG. 1 is the structural stereogram, FIG. 2 is the structural plan and FIG. 3 is the schematic view in using.

FIG. 4 to FIG. 9 are the schematic views of the first embodiment of the present invention. FIG. 4 and FIG. 5 are partial structural views of parts, FIG. 6 and FIG. 7 are overall structural views, FIG. 8 and FIG. 9 are schematic views in using, FIG. 8 is the schematic view when human body is independently borne by the suspension hole, and FIG. 9 is the schematic view when human body exerts pulling force on the control handle.

FIG. 10 and FIG. 11 are the schematic views of the second embodiment of the present invention.

FIG. 12 to FIG. 14 are the schematic views of the third embodiment of the present invention. FIG. 13 and FIG. 14 are the schematic views in using. FIG. 13 is the schematic view when human body is independently borne by the suspension hole, and FIG. 14 is the schematic view when human body exerts pulling force on the control handle.

FIG. 15 to FIG. 17 are the schematic views of the fourth embodiment of the present invention. FIG. 16 and FIG. 17 are the schematic views in using. FIG. 16 is the schematic view when human body is independently borne by the suspension hole, and FIG. 17 is the schematic view when human body exerts pulling force on the control handle.

FIG. 18 to FIG. 20 are the schematic views of the fifth embodiment of the present invention. FIG. 19 and FIG. 20 are the schematic views in using. FIG. 19 is the schematic view when human body is independently borne by the suspension hole, and FIG. 20 is the schematic view when human body exerts pulling force on the control handle.

FIG. 21 is the schematic view of the sixth embodiment of the present invention.

FIGS. 22-24 are the schematic views of the seventh embodiment of the present invention. FIG. 22 is structural plan, FIG. 23 is stereogram, and FIG. 24 is the schematic view after bending.

FIGS. 25-30 are the schematic views of the eighth embodiment of the present invention. FIGS. 25-27 are local part views, FIG. 28 and FIG. 29 are schematic views when the handle is opening, FIG. 29 is the schematic view of FIG. 28 from another prospective, FIG. 30 is the schematic view when it is showed that the handle is opening from the prospective of FIG. 28.

FIGS. 31-33 are the schematic views of the ninth embodiment of the present invention. FIG. 32 is the schematic view when suspending, FIG. 33 is the schematic view when descending.

In the figures, where:
1: Suspension body, 1.1A: The first rope-penetrating hole, 1.1B: The second rope-penetrating hole, 1.2: Suspension hole, 1.3: Waist, 1.4, 1.4A &1.4B: Control handle, 1.5.1&1.5.2: Fixed jacks, 1.6: locating part;
2: U-shaped rope-penetrating part, 2.1&2.2:Pins, 2A: The first U-shaped rope-penetrating part, 2B: The second U-shaped rope-penetrating part;
3.1: Fixed end of the suspend rope, 3.2: Free end of the suspend rope;
4: Fasteners;
5: Human body, 5.1, 5.1A&5.1B: Hands;
6: Pin roll.

### DETAILED DESCRIPTION OF THE INVENTION

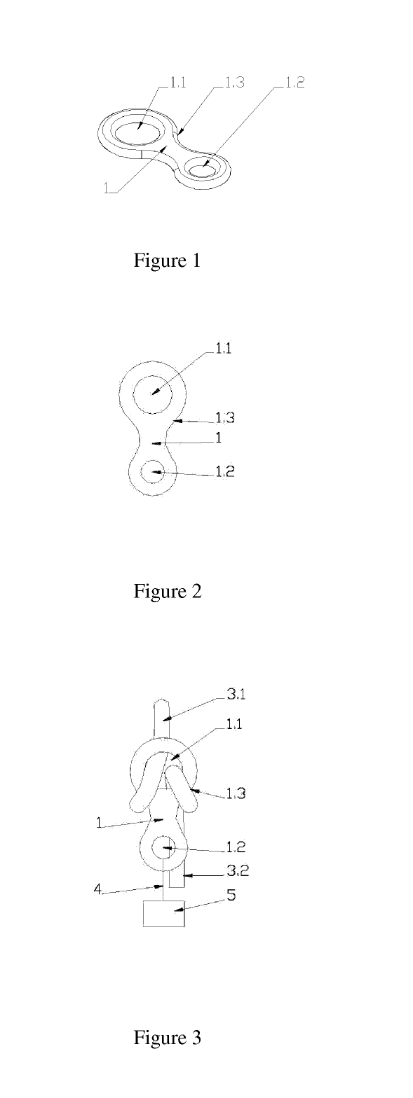

FIG. 1 to FIG. 3 are the schematic views of the existing 8-shaped ring suspension device. FIG. 1 is the structural stereogram, FIG. 2 is the structural plan and FIG. 3 is the schematic view in using.

Seen from FIG. 1 and FIG. 2, the existing 8-shaped ring suspension device mainly include suspension body 1 with rope-penetrating hole 1.1 and suspension hole 1.2.

Seen from FIG. 3 that is the schematic view in using, when used, the suspend rope passes through rope-penetrating hole 1.1 and is muff-coupled with waist 1.3 of the suspension body. Fixed end 3.1 of the suspend rope passes through rope-penetrating hole 1.1 and then is fixed on high, free end 3.2 of the suspend rope passes through rope-penetrating hole 1.1 and droops to the lower place, and human body 5 is fixed and connected with suspension hole 1.2 by fastener 4. In actual use, due to self-locking difficulty in the existing 8-shaped ring suspension device, users have to apply continuous pulling force to free end 3.2 of the suspend rope in a bid to control the rate of descent. In case it needs to hover in the air for a long time, the free end of the suspend rope must be fixed. For this reason, there are potentially certain safety risks during use for those without professional training due to inconvenient operation.

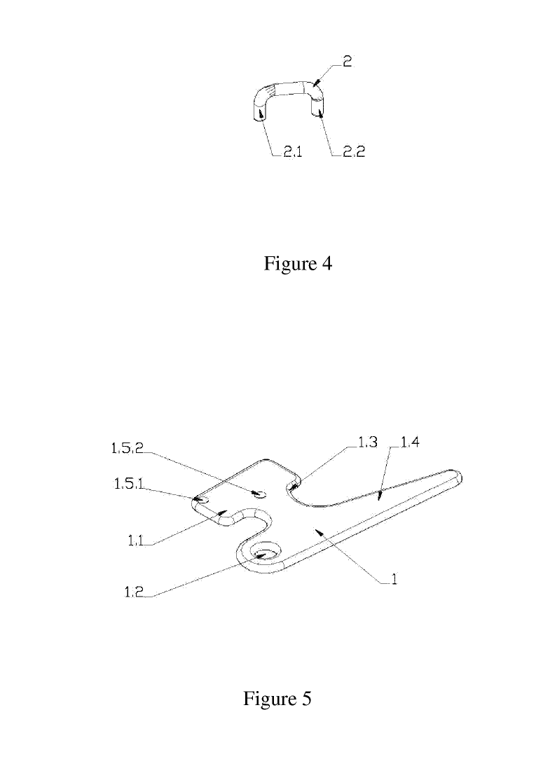

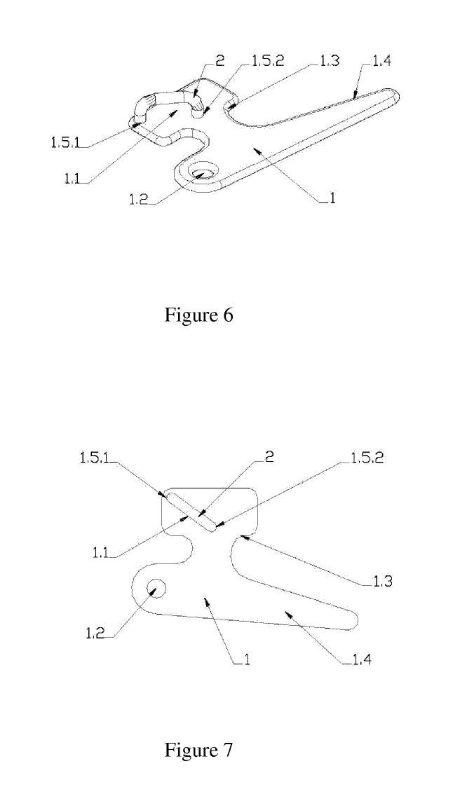

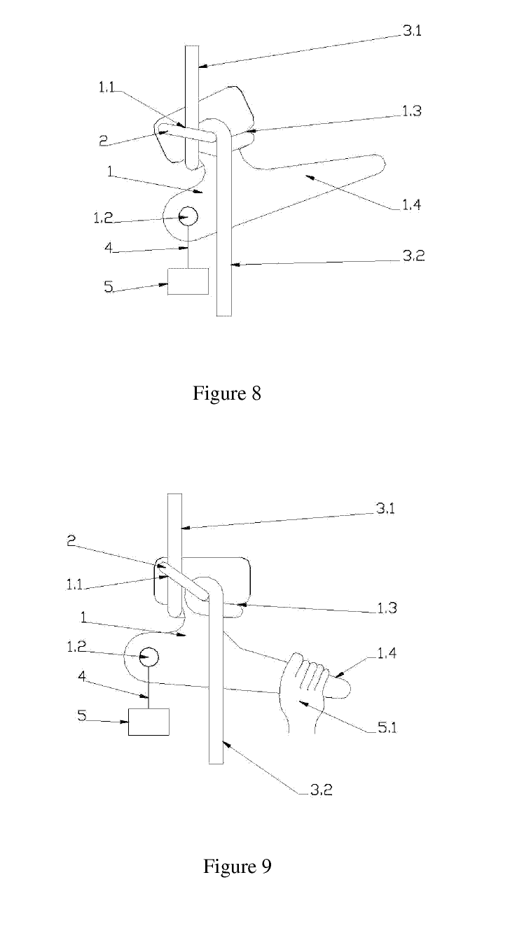

FIG. 4 to FIG. 9 are the schematic views of the first embodiment of the present invention. FIG. 4 and FIG. 5 are partial structural views of parts, FIG. 6 and FIG. 7 are overall structural views, FIG. 8 and FIG. 9 are schematic views in using, FIG. 8 is the schematic view when human body is independently borne by the suspension hole, and FIG. 9 is the schematic view when human body exerts pulling force on the control handle.

Seen from FIG. 4 to FIG. 7, in the current embodiment, the suspension device comprises suspension body 1.1 with suspension hole 1.2 and U-shaped rope-penetrating part 2 arranged on the suspension body. U-shaped rope-penetrating part 2 is made by bending round steels. The suspension body is provided with fixed jacks 1.5.1 and 1.5.2. The two pins 2.1 and 2.2 of the U-shaped rope-penetrating part are inserted in fixed jacks 1.5.1 and 1.5.2 respectively and welded with suspension body 1. U-shaped rope-penetrating part 2 is obliquely fastened on suspension body 1. There is rope-penetrating hole 1.1 between the U-shaped mouth of U-shaped rope-penetrating part 2 and the suspension body. The said suspension hole 1.2 is set in a position to one side, and a control handle 1.4 which controls the deflection of the suspension device is also provided on the other side of suspension body 1. In the current embodiment, Suspension hole 1.2 is located to one side and in a place below waist 1.3 of the suspension body. Control handle 1.4 is located in a place below waist 1.3 of the suspension body and on the other side of suspension hole 1.2.

FIG. 8 and FIG. 9 are the schematic views in using. Seen from FIG. 8, during use, the suspend rope passes through the rope-penetrating hole 1.1 and is muff-coupled with the waist 1.3 of the suspension body; the fixed end 3.1 of the suspend rope passes through the rope-penetrating hole 1.1 and then is fixed on high, the free end 3.2 of the suspend rope passes through the rope-penetrating hole 1.1 and droops to the lower place, and the human body 5 is fixed and connected with the suspension hole 1.2 by fastener 4. When the human body 5 is independently borne by the suspension hole 1.2, in rope-penetrating hole 1.1, the fixed end 3.1 and the free end 3.2 of the suspend rope touch and press tightly with each other to prevent the suspend rope from sliding and keep the human body hovering on the high and the suspension device in self-locking status.

Seen from FIG. 9, when necessary, the human body can descend by exerting downward pulling force on the suspension device with hands 5.1 through control handle 1.4 to force the suspension device to deflect. So, in rope-penetrating hole 1.1, the pressure between the fixed end 3.1 and the free end 3.2 reduces or the two ends separate from each other. At this time, the human body begins to descend with the rope sliding. To lower the speed of human body 5 or stop descending, it just needs to reduce the downward pulling force on control handle 1.4. In doing so, the suspension device will deflect reversely to make the fixed end 3.1 and the free end 3.2 in rope-penetrating hole 1.1 press tightly with each other. As a result, the pressure between them is increased, which enables human body 5 to slow down or hover in the air.

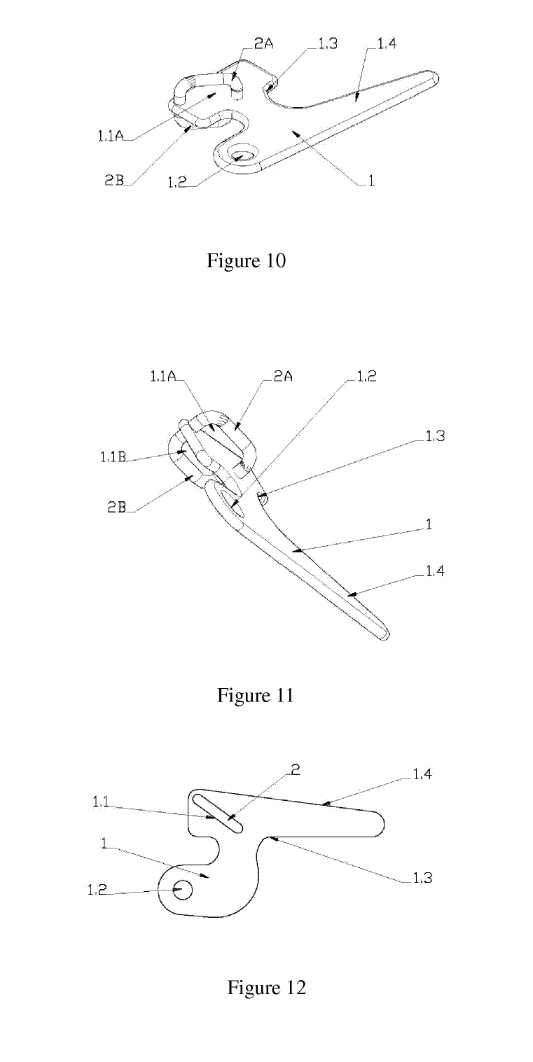

FIG. 10 and FIG. 11 are the schematic views of the second embodiment of the present invention. Seen from FIG. 10 and FIG. 11, the difference from the first embodiment is that, in the current embodiment, the first U-shaped rope-penetrating part 2A and the second U-shaped rope-penetrating part 2B are arranged on the said suspension body 1 separately. Due to different sizes of U-shaped mouths of the first U-shaped rope-penetrating part 2A and the second U-shaped rope-penetrating part 2B, the first rope-penetrating hole 1.1A and the second rope-penetrating hole 1.1B differ in size. In practice, different rope-penetrating holes may be considered for specific types of suspend ropes. Today, ropes (static ropes) used for suspending and descending have various seizes, including Φ10 mm, Φ11 mm, Φ12 mm and Φ16 mm. Addition of rope-penetrating holes enables the suspension device to better adapt to ropes of different sizes.

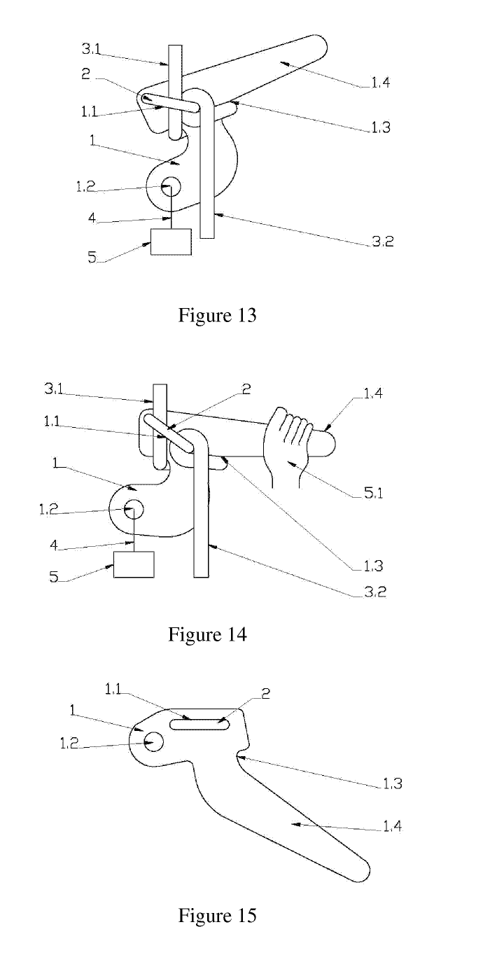

FIG. 12 to FIG. 14 are the schematic views of the third embodiment of the present invention. FIG. 13 and FIG. 14 are the schematic views in using. FIG. 13 is the schematic view when human body is independently borne by the suspension hole, and FIG. 14 is the schematic view when human body exerts pulling force on the control handle. Seen from these figures, the difference from the first embodiment is that, in the current embodiment, the said suspension hole 1.2 is located to one side and in a place below the waist 1.3 of the suspension body. The said control handle 1.4 is located in a place above the waist 1.3 of the suspension body and on the other side of the suspension hole 1.2.

Seen from FIG. 13, during use, when the human body 5 is independently borne by suspension hole 1.2, in rope-penetrating hole 1.1, fixed end 3.1 and free end 3.2 of the suspend rope touch and press tightly with each other to prevent the suspend rope from sliding and keep the human body hovering on the high and the suspension device in self-locking status. Seen from FIG. 14, exerting downward pulling force on control handle 1.4 with hands 1.5 allows to control the deflection of the suspension device. Therefore, in rope-penetrating hole 1.1, the pressure between fixed end 3.1 and free end 3.2 reduces or fixed end 3.1 separate from free end 3.2. At this time, the human body begins to descend with the rope sliding.

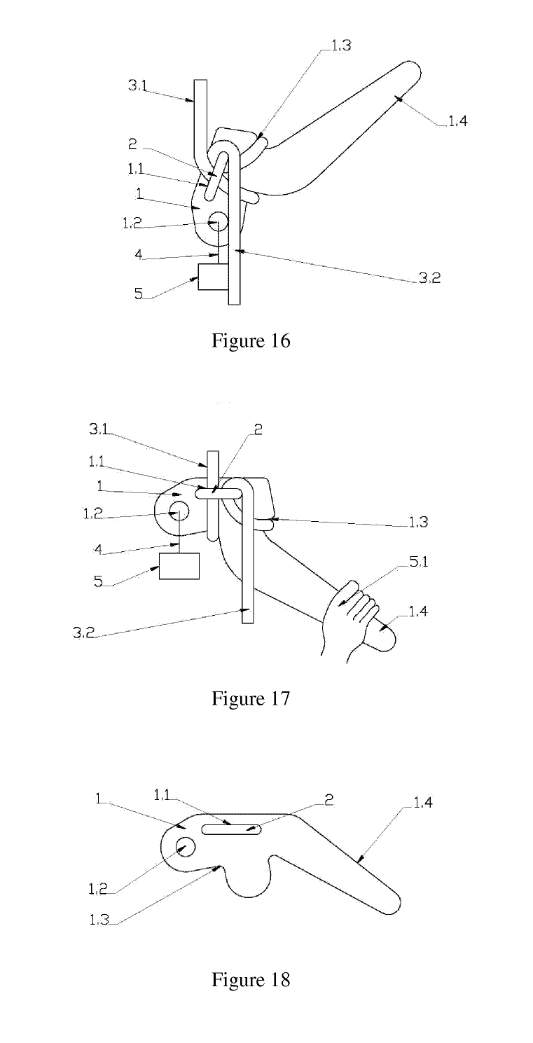

FIG. 15 to FIG. 17 are the schematic views of the fourth embodiment of the present invention. FIG. 16 and FIG. 17 are the schematic views in using. FIG. 16 is the schematic view when human body is independently borne by the suspension hole, and FIG. 17 is the schematic view when human body exerts pulling force on the control handle. Seen from these figures, the difference from the first embodiment is that, in the current embodiment, the said suspension hole 1.2 is located to one side and in a place above the waist 1.3 of the suspension body. The said control handle 1.4 is located in a place below the waist 1.3 of the suspension body and on the other side of the suspension hole 1.2.

Seen from FIG. 16, during use, when the human body 5 is independently borne by suspension hole 1.2, in rope-penetrating hole 1.1, fixed end 3.1 and free end 3.2 of the suspend rope touch and press tightly with each other to prevent the suspend rope from sliding and keep the human body hovering on the high and the suspension device in self-locking status. Seen from FIG. 17, exerting downward pulling force on control handle 1.4 with hands 1.5 allows to control the deflection of the suspension device. Therefore, in rope-penetrating hole 1.1, the pressure between fixed end 3.1 and free end 3.2 reduces or fixed end 3.1 separate from free end 3.2. At this time, the human body begins to descend with the rope sliding.

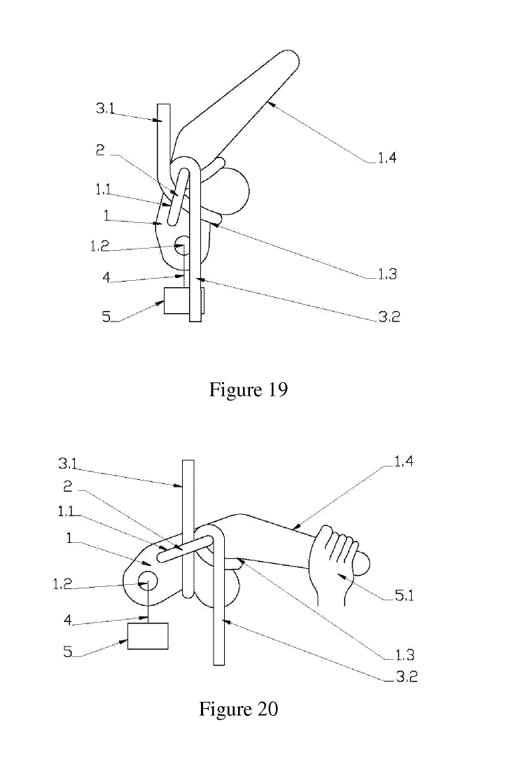

FIG. 18 to FIG. 20 are the schematic views of the fifth embodiment of the present invention. FIG. 19 and FIG. 20 are the schematic views in using. FIG. 19 is the schematic view when human body is independently borne by the suspension hole, and FIG. 20 is the schematic view when human body exerts pulling force on the control handle. Seen from these figures, the difference from the first embodiment is that, in the current embodiment, the said suspension hole 1.2 is located to one side and in a place above the waist 1.3 of the suspension body. The said control handle 1.4 is located in a place above the waist 1.3 of the suspension body and on the other side of the suspension hole 1.2.

Seen from FIG. 19, during use, when the human body 5 is independently borne by suspension hole 1.2, in rope-penetrating hole 1.1, fixed end 3.1 and free end 3.2 of the suspend rope touch and press tightly with each other to prevent the suspend rope from sliding and keep the human body hovering on the high and the suspension device in self-locking status. Seen from FIG. 20, exerting downward pulling force on control handle 1.4 with hands 1.5 allows to control the deflection of the suspension device. Therefore, in rope-penetrating hole 1.1, the pressure between fixed end 3.1 and free end 3.2 reduces or fixed end 3.1 separate from free end 3.2. At this time, the human body begins to descend with the rope sliding.

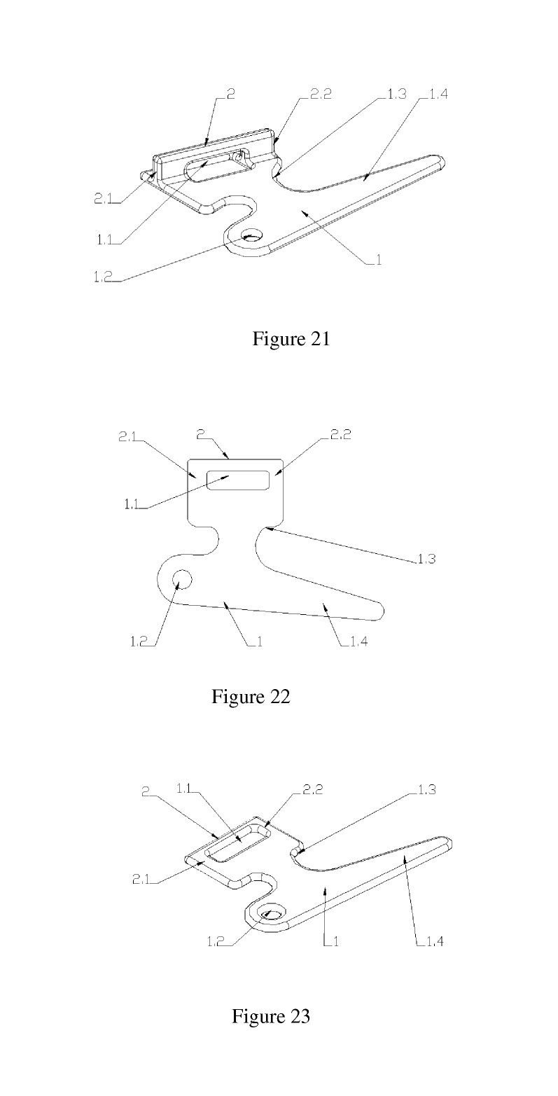

FIG. 21 is the schematic view of the sixth embodiment of the present invention. See from FIG. 21, the difference from the first embodiment is that, in current embodiment, the U-shaped rope-penetrating part 2 and suspension body 1 are integrated casting structure.

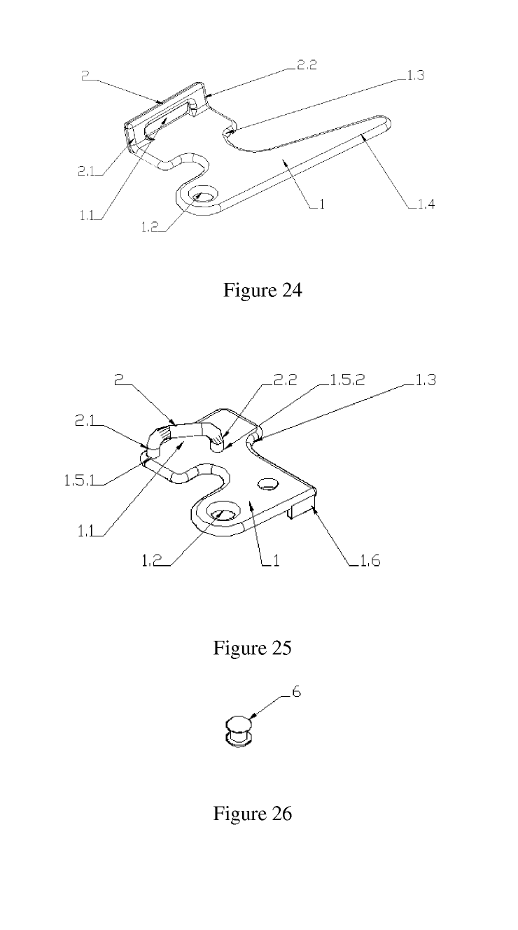

FIGS. 22-24 are the schematic views of the seventh embodiment of the present invention. FIG. 22 is structural plan, FIG. 23 is stereogram, and FIG. 24 is the schematic view after bending. See from the figures, the difference from the first embodiment is that, in current embodiment, the said U-shaped rope-penetrating part 2 and suspension body 1 are integrated casting structure, and the U-shaped rope-penetrating is made by bending round steels. See from FIG. 23, the suspension device is flat plate structure before bending; See from FIG. 24, bending is carried out in pin root of U-shaped part.

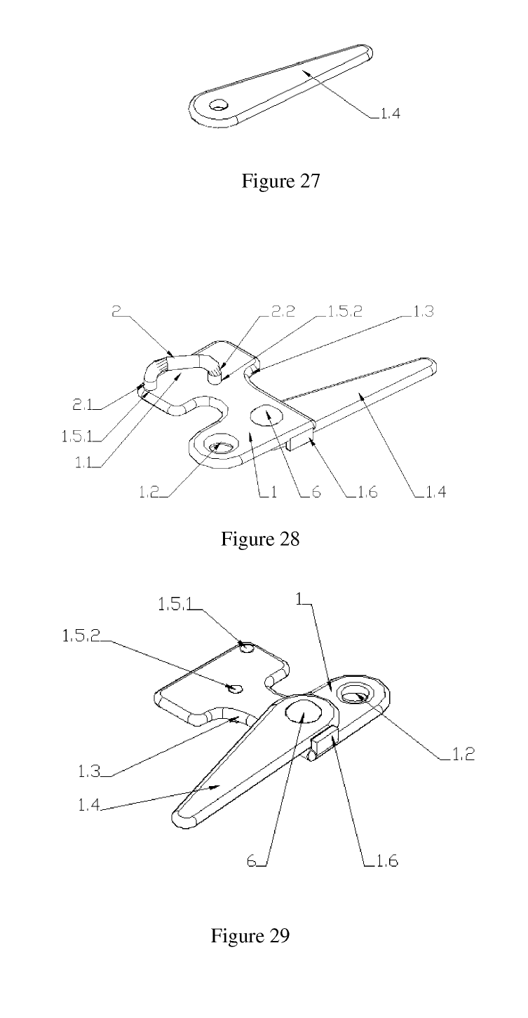

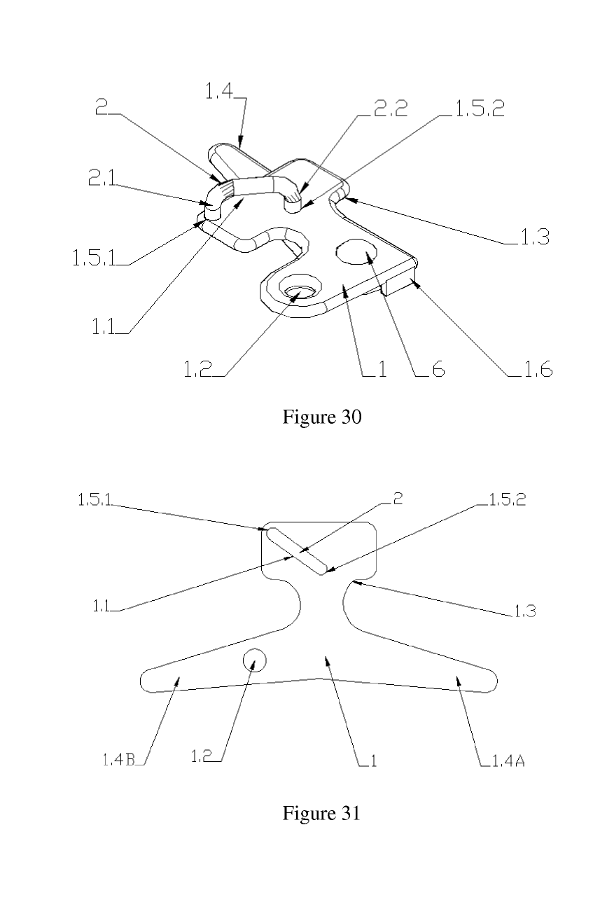

FIGS. 25-30 are the schematic views of the eighth embodiment of the present invention. FIGS. 25-27 are local part views, FIG. 28 and FIG. 29 are schematic views when the handle is opening, FIG. 29 is the schematic view of FIG. 28 from another prospective, FIG. 30 is the schematic view when it is showed that the handle is opening from the prospective of FIG. 28. See from the figures, the difference from the first embodiment is that, in current embodiment, control handle 1.4 is folding handle, folding handle 1.4 is adopted on suspension body 1 with pin roll 6, suspension body 1 has handle locating part 1.6, folding handle 1.4 can rotate around pin roll 6 and be located with locating part 1.6. See from FIG. 28 and FIG. 29, when the handle needs to be opened, handle 1.4 rotates around pin roll 6 and is located with locating part 1.6; See from FIG. 30, when the handle needs to be folded, folding handle 1.4 rotates around pin roll 6 and is folded with suspension body 1 together.

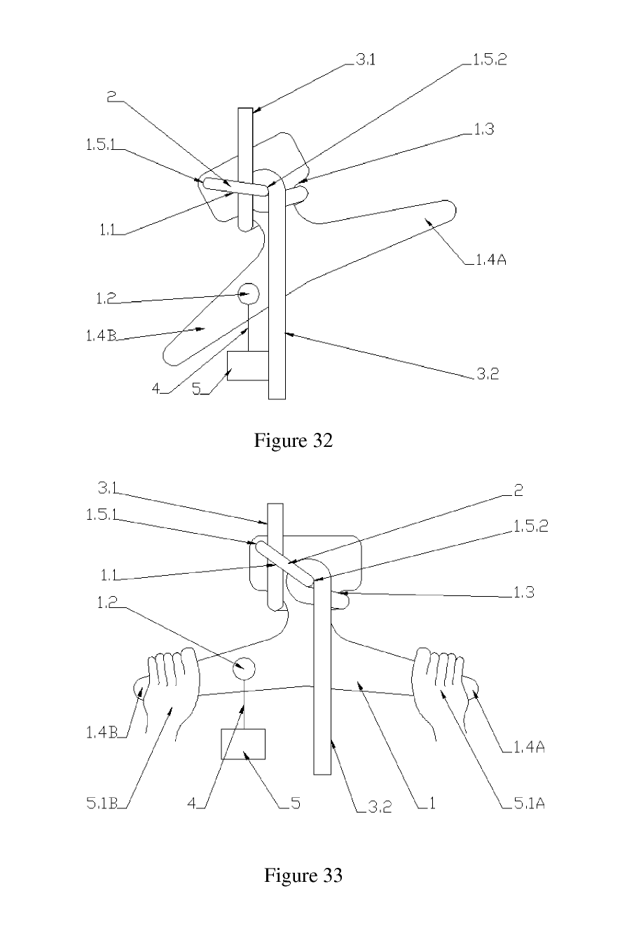

FIGS. 31-33 are the schematic views of the ninth embodiment of the present invention. FIG. 32 is the schematic view when suspending, FIG. 33 is the schematic view when descending. See from the figures, the difference from the first embodiment is that, in current embodiment, the suspension device is structured of double control handle, control handle 1.4 A and 1.4 B which control the deflection of suspension device are located on both sides of said suspension body 1; See from FIG. 33, when human body is descending while the two handles working, two hands of human body 5.1A and 5.1B can respectively hold the handle 1.4 A and 1.4 B on both sides of suspension device in favor of balance of human body, in process of descending, adjust the descending speed with deflection of suspension device.

The present invention prompts that the structural feature of the sixth embodiment can also be applied in the above third, fourth, fifth, eighth or ninth embodiment.

The present invention prompts that the structural feature of the seventh embodiment can also be applied in the above eighth or ninth embodiment.

The present invention prompts that the structural feature of the eighth or ninth embodiment can also be applied in the above second, third, fourth or fifth embodiment.

The present invention prompts that, in other embodiments, U-shaped rope-penetrating parts can be fastened on the suspension body without inclination.

The present invention prompts that, in other embodiments, a pull cord can also be adopted on the other side of the suspension hole to control the deflection of the suspension device. Anything can be used to achieve the purposes of the present invention as the control handle does, as long as it can facilitate the deflection of the suspension device.

The present invention prompts that, in other embodiments, U-shaped rope-penetrating parts can be fastened with the suspension body through other well-known methods.

1. A suspension device, wherein, the suspension device comprises a suspension body with a suspension hole and a u-shaped rope-penetrating part arranged on the suspension body; the u-shaped mouth of the u-shaped rope-penetrating part together with the suspension body form a rope-penetrating hole; the said suspension hole is set in a position to one side, and a control handle which controls the deflection of the suspension device is also provided on the other side of the suspension body; the suspend rope passes through the rope-penetrating hole and is muff-coupled with the waist of the suspension body; the fixed end of the suspend rope passes through the rope-penetrating hole and then is fixed on high, the free end of the suspend rope passes through the rope-penetrating hole and droops to the lower place, and the human body is fixed and connected with the suspension hole by fasteners, when the human body is independently borne by the suspension hole, the fixed end and the free end of the suspend rope touch and press tightly with each other to prevent the suspend rope from sliding and keep the human body suspended on the high, when the human body exerts pulling force on the suspension device through the control handle, the suspension device deflects so as to reduce the pressure between the fixed end and the free end or separate the fixed end from the free end; at this time, the human body begins to descend with the rope sliding.

2. The suspension device of claim 1, wherein, the said U-shaped rope-penetrating part is made by bending round steels; the said suspension body is provided with fixed jacks; the two pins of the said U-shaped rope-penetrating part are inserted and welded in the fixed jacks respectively.

3. The suspension device of claim 1, wherein, the said U-shaped rope-penetrating part and suspension body are integrated casting structure.

4. The suspension device of claim 1, wherein, the suspension device is structured of double control handle; control handles which control the deflection of suspension device are located on both sides of said suspension body.

5. The suspension device of claim 1, wherein, the said U-shaped rope-penetrating part is obliquely fastened on the suspension body.

6. The suspension device of claim 1, wherein, a U-shaped rope-penetrating part is provided on each of the two sides of the said suspension body.

7. The suspension device of claim 1, wherein, the said suspension hole is located to one side and in a place below the waist of the suspension body, the said control handle is located in a place below the waist of the suspension body and on the other side of the suspension hole.

8. The suspension device of claim 1, wherein, the said suspension hole is located to one side and in a place below the waist of the suspension body, the said control handle is located in a place above the waist of the suspension body and on the other side of the suspension hole.

9. The suspension device of claim 1, wherein, the said suspension hole is located to one side and in a place above the waist of the suspension body, the said control handle is located in a place below the waist of the suspension body and on the other side of the suspension hole.

10. The suspension device of claim 1, wherein, the said suspension hole is located to one side and in a place above the waist of the suspension body, the said control handle is located in a place above the waist of the suspension body and on the other side of the suspension hole.

11. The suspension device of claim 2, wherein, the said suspension hole is located to one side and in a place below the waist of the suspension body, the said control handle is located in a place below the waist of the suspension body and on the other side of the suspension hole.

12. The suspension device of claim 2, wherein, the said suspension hole is located to one side and in a place below the waist of the suspension body, the said control handle is located in a place above the waist of the suspension body and on the other side of the suspension hole.

13. The suspension device of claim 2, wherein, the said suspension hole is located to one side and in a place above the waist of the suspension body, the said control handle is located in a place below the waist of the suspension body and on the other side of the suspension hole.

14. The suspension device of claim 2, wherein, the said suspension hole is located to one side and in a place above the waist of the suspension body, the said control handle is located in a place above the waist of the suspension body and on the other side of the suspension hole.

15. The suspension device of claim 4, wherein, the said suspension hole is located to one side and in a place below the waist of the suspension body, the said control handle is located in a place below the waist of the suspension body and on the other side of the suspension hole.

16. The suspension device of claim 4, wherein, the said suspension hole is located to one side and in a place below the waist of the suspension body, the said control handle is located in a place above the waist of the suspension body and on the other side of the suspension hole.

17. The suspension device of claim 4, wherein, the said suspension hole is located to one side and in a place above the waist of the suspension body, the said control handle is located in a place below the waist of the suspension body and on the other side of the suspension hole.

18. The suspension device of claim 4, wherein, the said suspension hole is located to one side and in a place above the waist of the suspension body, the said control handle is located in a place above the waist of the suspension body and on the other side of the suspension hole.
